(19) United States
(12) Patent Application Publication
(10) Pub. No.: US 2025/0358747 A1
(43) Pub. Date: Nov. 20, 2025

(54) METHOD AND DEVICE FOR JOINT OPERATION OF TIME-AVERAGED SPECIFIC ABSORPTION RATE ALGORITHM AND BODY PROXIMITY SENSOR

(71) Applicant: Samsung Electronics Co., Ltd., Gyeonggi-do (KR)

(72) Inventors: Mahmoud Esam Mohamed Ahmed ABDELGELIL, San Diego, CA (US); Pranav DAYAL, San Diego, CA (US); Wan Jong KIM, San Diego, CA (US)

(21) Appl. No.: 18/887,251

(22) Filed: Sep. 17, 2024

Related U.S. Application Data
(60) Provisional application No. 63/647,810, filed on May 15, 2024.

(51) Int. Cl. H04W 52/36; H04B 1/3827; H04W 52/22

(52) U.S. Cl. CPC H04W 52/367; H04B 1/3838; H04W 52/225

(57) ABSTRACT

A method and device are provided in which a proximity sensor of a user equipment (UE) determines an object detection status change for a first antenna of the UE. A processor of the UE controls a transmission power of the first antenna based on the object detection status and one of a first delay period for initial object detection by the proximity sensor or a second delay period of detection status change certainty. The transmission power changes between an upper power level and a lower power level in accordance with a time-averaged specific absorption rate (SAR) (TAS).

### CROSS-REFERENCE TO RELATED APPLICATION

This application claims the priority benefit under 35 U.S.C. § 119 (e) of U.S. Provisional Application No. 63/647,810, filed on May 15, 2024, the disclosure of which is incorporated by reference in its entirety as if fully set forth herein.

### TECHNICAL FIELD

The disclosure generally relates to transmission power control of a wireless communication device. More particularly, the subject matter disclosed herein relates to improvements to time-averaged specific absorption rate (SAR) (TAS) methods using a body proximity sensor (BPS).

### SUMMARY

For wireless communication, limits that are applied by regulators (e.g., Federal Communications Commission (FCC) and Innovation, Science and Economic Development (ISED)) may decrease the transmission power of a wireless communication device or user equipment (UE). A TAS algorithm may be used to allow for more power transmissions during an operating time while keeping the average power level to the regulatory levels.

This average power level may be determined based on the proximity of a human object to the UE. BPSs may be used to determine the proximity of the human object to the UE.

One issue with the above approach is that BPSs may introduce errors that may affect compliance with regulations, most notably with respect to millimeter wave (mmwave) operation in which an average period is short.

To overcome these issues, systems and methods are described herein for mutual operation of different types of BPSs and different TAS algorithm types.

The above approaches improve on previous methods because they lessen the effect of errors in BPSs.

In an embodiment, a method is provided in which a proximity sensor of a UE determines an object detection status change for a first antenna of the UE. A processor of the UE controls a transmission power of the first antenna based on the object detection status and one of a first delay period for initial object detection by the proximity sensor or a second delay period of detection status change certainty. The transmission power changes between an upper power level and a lower power level in accordance with TAS.

In an embodiment, a UE is provided that includes a processor and a non-transitory computer readable storage medium storing instructions. When executed, the instructions cause the processor to determine, by a proximity sensor of the UE, an object detection status change for a first antenna of the UE. The instructions also cause the processor to control a transmission power of the first antenna based on the object detection status and one of a first delay period for initial object detection by the proximity sensor or a second delay period of detection status change certainty. The transmission power changes between an upper power level and a lower power level in accordance with TAS.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a communication system;

FIG. 2 is a diagram illustrating a TAS transmission pattern;

FIG. 3 is a diagram illustrating TAS control in a first scenario based on a BPS delay, according to an embodiment;

FIG. 4 is a diagram illustrating TAS control for a second scenario based on a misdetection window, according to an embodiment;

FIG. 5 is a diagram illustrating a UE with two antennas, according to an embodiment;

FIG. 6 is a diagram illustrating antenna switching by the spatial TAS for highest power transmission, according to an embodiment;

FIG. 7 is a diagram illustrating spatial TAS control for a scenario in which no objects are in close proximity to the antennas, according to an embodiment;

FIG. 8 is a diagram illustrating spatial TAS control for a scenario in which respective objects are originally in close proximity to the antennas, according to an embodiment;

FIG. 9 is a flowchart illustrating a method for controlling transmission power of an antenna; and

FIG. 10 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

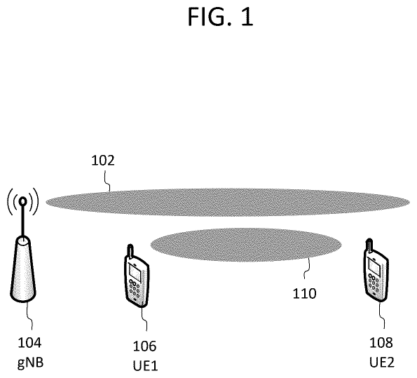

FIG. 1 is a diagram illustrating a communication system, according to an embodiment. In the architecture illustrated in FIG. 1, a control path 102 may enable the transmission of control information through a network established between a base station, access point (AP), or a gNode B (gNB) 104, a first UE 106, and a second UE 108. A data path 110 may enable the transmission of data (and some control information) between the first UE 106 and the second UE 108. The control path 102 and the data path 110 may be on the same frequency or may be on different frequencies.

Regulators place limits on the average SAR and the power density (PD). To comply with those limits, a UE adapts its transmitting power such that the overall average of SAR and/or PD does not exceed the regulatory limit. A UE transmitting power and PD may be linearly related at a specific distance between the UE and an object. This power-PD relationship may be demonstrated in Equation (1) below:

$$PD ( d ) = f ( d ) \times P \qquad ( 1 )$$

where d is the distance between the UE and the object and f(d) is a distance dependent value.

The maximum PD allowed by regulators is referred to as the compliance level and may be referred to as PD_{regulator}. This value remains fixed regardless of the distance between the UE and the object and regardless of the UE transmitting power. At a specific distance, a maximum power may be determined such that the PD level does not exceed the compliance level. This maximum power may be referred to as a limit power Pₗᵢₘᵢₜ. Regulators may assign the SAR/PD compliance level as an average level over a specific window of T_{cycle} seconds (e.g., 4 seconds). Accordingly, an instantaneous PD level may exceed the compliance level as long as the average PD is below the compliance level. A TAS algorithm that determines the maximum SAR/PD level at any time may be used such that the instantaneous transmitted power levels swing between two power levels one above Pₗᵢₘᵢₜ and one below it. The TAS may control a maximum power transmission over small sub-windows (e.g., 250 milliseconds (ms)) so that the overall average PD over T_{cycle} is below the PD_{regulator}. Thus, according to the Pₗᵢₘᵢₜ value and the target power at each sub-window, the TAS may determine the transmission over all sub-windows.

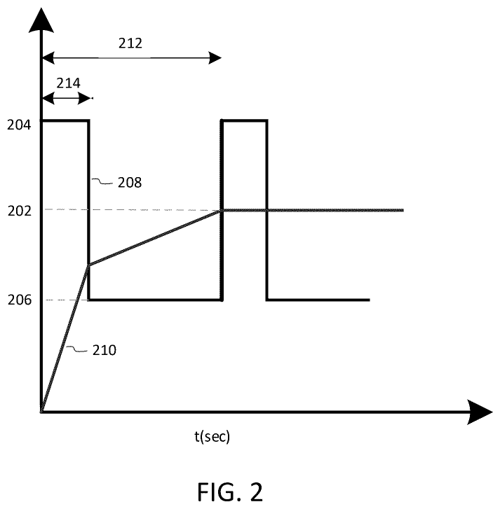

FIG. 2 is a diagram illustrating a TAS transmission pattern. Specifically, the TAS transmission pattern is for a specific value of Pₗᵢₘᵢₜ 202 and a target power set at Pₘₐₓ 204 (which is defined as the UE maximum power), with TAS operating at an instantaneous signal power 208 between two levels, Pₘₐₓ 204 and Pₗᵢₘᵢₜ (dBm)-3 dB 206. A moving average power 210 at or below Pₗᵢₘᵢₜ 202 is determined over an average period of T_{cycle} 212.

Assuming a target average power of c×Pₗᵢₘᵢₜ (to allow for a margin below the regulatory level), the amount of time that TAS can allow the transmission at Pₘₐₓ within this T_{cycle} 208, denoted as Tₘₐₓ 214, can be computed as Equation (2) below:

$${T}_{max} = \frac{c - 0.5}{\frac{{P}_{max}}{{P}_{limit}} - 0.5} {T}_{cycle} \qquad ( 2 )$$

If this T_{cycle} window 212 is divided into M sub-windows (each of T_{w} seconds) over which the TAS decision is fixed, Equations (3) and (4) may be obtained as set forth below:

$${T}_{cycle} = {MT}_{w} \qquad ( 3 )$$

$${T}_{max} = {M}_{max} {T}_{w} \qquad ( 4 )$$

where T_{w} is the time duration of each sub-window. Thus, Mₘₐₓ may be computed (which is the number of sub-windows where Pₘₐₓ transmission is allowed within T_{cycle}) as shown in Equation (5) below:

$${M}_{max} = ⌊ \frac{c - 0.5}{\frac{{P}_{max}}{{P}_{limit}} - 0.5} M ⌋ \qquad ( 5 )$$

The value of Pₗᵢₘᵢₜ may depend on multiple parameters such as, for example, band, antenna, and distance from the human object. The band of operation and transmitting antenna are well known to the TAS and the physical layer (PHY) and the Pₗᵢₘᵢₜ may be easily changed if one of them is changed. However, object presence and distance from the UE is not known to TAS.

Generally there exists an inverse relationship between PD and distance with respect to a fixed transmitted power level from the UE. The regulatory limit for PD is set at PD_{regulator} where the PD at any distance should be below this limit. If a BPS is not present to determine the proximity of the target or its distance, then the UE may transmit in accordance with a worst-case scenario (e.g., assuming a minimum distance between the UE and the object) to comply with the regulatory PD limit at any distance. Hence, the value of Pₗᵢₘᵢₜ 202 becomes very low resulting in a low power transmission at all times even if no object exists or the object is far.

If BPS is present the above-described power transmission behavior may be improved. A first type of BPS may determine only the proximity of the object within a pre-determined range. If the BPS detects the proximity for any object within x centimeters (cm), and if a target object is located within x cm from the UE, the BPS detects the proximity of that object.

Thus, for this first type of BPS, there may be two values for Pₗᵢₘᵢₜ for TAS. The first value P_{limit,1} is a worst-case scenario in which a distance between the object and the UE is lowest. This first value may be used when the BPS detects proximity of the target. If the BPS does not detect proximity of the target because the target is beyond the x cm distance, a second value P_{limit,2} is used, which is set at the highest power level that also keeps PD at the x cm lower than PD_{regulatory}.

A second type of BPS may determine whether an object is within the BPS proximity region, and may determine whether the target is moving toward or away from the UE.

A third type of BPS may determine the distance to the target with precision. The overall transmission performance may be enhanced in cases in which the target is not close to the UE. Additionally, multiple values of Pₗᵢₘᵢₜ may be provided based on the BPS precision. For example, if the maximum distance that can be detected is 20 cm and the BPS detection precision is 1 cm, then the TAS may operate using 20 values of Pₗᵢₘᵢₜ.

For the first type of BPS described above, the TAS may consider two scenarios. In a first scenario, an object appears in front of the UE after a duration during which no object was present. The value of Pₗᵢₘᵢₜ must decrease significantly and the TAS should operate at the new P_{limit,1}. If the BPS correctly detects presence of the target, then regulatory compliance is guaranteed. However, the BPS may mis-detect the presence of the object and the higher Pₗᵢₘᵢₜ value (P_{limit,2}) remains unchanged during the mis-detection period. This mis-detection may yield non-compliance with respect to the total average PD.

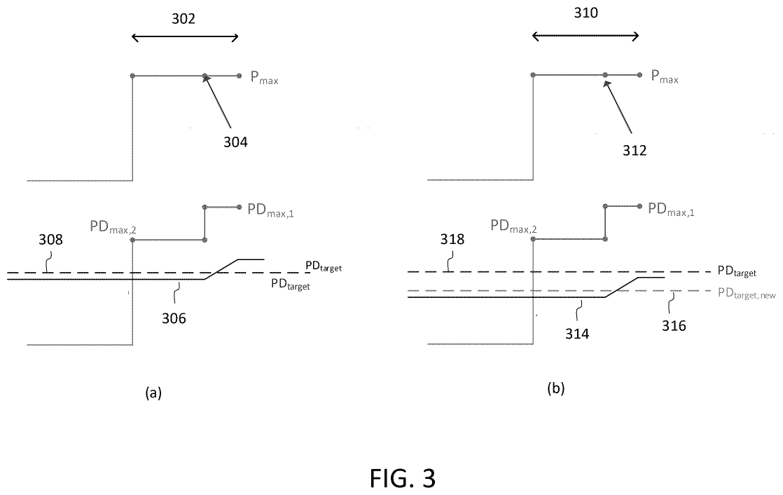

FIG. 3 is a diagram illustrating TAS control in a first scenario based on a BPS delay, according to an embodiment. As shown in (a) of FIG. 3, a number of windows 302 at Pₘₐₓ may be determined based on an original PD target without an object in proximity of the antenna. The object may enter proximity of the antenna at 304 during a Pₘₐₓ interval, but the BPS may not detect the object. Accordingly, PD_{max,2} increases to PD_{max,1} at the time the object enters, which increases an actual average PD 306 to exceed PD_{target} 308.

Mutual operation of the TAS with the BPS may provide multiple benefits that may deal with this mis-detection. For example, the TAS PD target may be set based on a maximum misdetection time of the BPS, after which the BPS may detect correctly. By knowing this maximum lag, the TAS may set its target average power (by lowering the value of c) to absorb any mis-detection that occurs in the BPS. The TAS may operate as shown in (b) of FIG. 3 and set forth below.

First, for P_{limit,2} (which is the higher Pₗᵢₘᵢₜ), the TAS may compute a maximum number of sub-windows (mₘₐₓ) that a maximum power (Pₘₐₓ) transmission is allowed within the regulatory average duration that consists of M windows, in accordance with Equation (5).

Second, the TAS may compute the PD corresponding to the maximum power (Pₘₐₓ) when P_{limit,2} is applied as

$${PD}_{max , 2} = {P}_{max} \times \frac{{PD}_{regulator}}{{P}_{limit , 2}} .$$

Third, the TAS may compute the PD corresponding to the maximum power when P_{limit,1} is applied as

$${PD}_{max , 1} = {P}_{max} \times \frac{{PD}_{regulator}}{{P}_{limit , 1}} .$$

Fourth, assuming a maximum delay of BPS as δ_{BPS,max} sub-windows, the TAS may compute the excess average PD of M windows as

$${\overline{PD}}_{excess} = \frac{\begin{matrix}( {m}_{max} - {δ}_{BPS , max} ) \times {PD}_{max , 2} + \\ {δ}_{BPS , max} \times {PD}_{max , 1} + 0.5 x ( M - {m}_{max} ) \times {PD}_{regulator}\end{matrix}}{M} .$$

Fifth, assuming an original PD target is PD_{target}, the TAS may compute the excess factor as

$${δ}_{PD , excess} = \frac{{\overline{PD}}_{excess}}{{PD}_{target}} .$$

Sixth, the TAS may set the new PD target as

$${PD}_{target , new} = \frac{{PD}_{target}}{{δ}_{PD , excess}} and so {c}_{new} = \frac{c}{{δ}_{PD , excess}} .$$

An example may be provided in which M=100, P_{limit,1}=18 dBm, P_{limit,2}=20 dBm, Pₘₐₓ=23 dBm, PD_{regulator}=1 w/m²,

$${PD}_{target} = 0.9 W / {m}^{2} ( hence c = \frac{{PD}_{target}}{{PD}_{regualtor}} = 0.9 )$$

and δ_{BPS,max}=2 sub-windows. In addition, it may be assumed that the TAS always cycles between the maximum instantaneous power (Pₘₐₓ) of 23 dBm and a minimum power of Pₗᵢₘᵢₜ (dBm)-3 dB (where Pₗᵢₘᵢₜ is either P_{limit,1} or P_{limit,2}). Thus, from PD perspective, the Pₗᵢₘᵢₜ always corresponds to the PD limit which is, for example, 1 W/m².

Accordingly, for P_{limit,2} (the higher Pₗᵢₘᵢₜ), mₘₐₓ may be calculated as 26 sub-windows using Equation (5). The PD corresponding to the maximum power (Pₘₐₓ) when P_{limit,2} is applied may be

$${PD}_{max , 2} = 1 {0}^{2.3} \times \frac{1}{{10}^{2}} = 1 {0}^{0.3} W / {m}^{2} .$$

The PD corresponding to the maximum power when P_{limit,1} is applied may be

$${PD}_{max , 1} = 1 {0}^{2.3} \times \frac{1}{{10}^{1.8}} = 1 {0}^{0.5} W / {m}^{2} .$$

Assuming the maximum delay of BPS as δ_{BPS,max}=2, the excess average PD of M windows may be

$${\overline{PD}}_{excess} = \frac{( 26 - 2 ) \times {10}^{0.3} + 2 \times {10}^{0.5} + ( 100 - 26 ) \times 0.5}{100} = 0.9 \; 12 W / {m}^{2} .$$

Assuming the original PD target is PD_{target}=0.9 W/m², the excess factor may be

$${δ}_{PD , excess} = \frac{{\overline{PD}}_{excess}}{{PD}_{target}} = \frac{0.912}{0.9} = 1.0133 .$$

The new TAS PD target may be

$${PD}_{target , new} = \frac{{PD}_{target}}{{δ}_{PD , excess}} = \frac{0.9}{1.0133} = 0.88 \frac{W}{{m}^{2}} ,$$

$$and thus , {c}_{n e w} = \frac{c}{{δ}_{PD , excess}} \frac{0.9}{1.0133} = 0.88 .$$

By using this lower target PD, TAS at P_{limit,2} will have only 25 sub-windows using Equation (5). Therefore, if the BPS mis-detects, the worst case average SAR becomes

$$\frac{23 \times 1 {0}^{0.3} + 2 \times 1 {0}^{0.5} + 75 * 0.5}{100} = 0.897 W / {m}^{2} < 0.9 W / {m}^{2} .$$

After the BPS confirms the detection, the target PD may return to its original target, as this will be the worst case Pₗᵢₘᵢₜ value (P_{limit,1}).

As shown in (b) of FIG. 3, the number of windows 310 for Pₘₐₓ are determined based on the new target PD, making the number of windows 310 less than the number of windows 302 in (a). The object may enter proximity of the antenna at 312 during a Pₘₐₓ interval, but the BPS may not detect the object. Accordingly, PD_{max,2} increases to PD_{max,1} at the time the object enters, which increases an actual average PD 314 which exceeds the PD_{target},new 316, but remains below PD_{target} 318.

In a second scenario for the first type of BPS, an object in close proximity to the UE and is no longer detected, resulting in the Pₗᵢₘᵢₜ changing from a low value (P_{limit,1}) to a high value (P_{limit,2}). This scenario may occur as a misdetection indicating that no object is there, when the object remains present. If the TAS switched to the higher Pₗᵢₘᵢₜ there will be an extra PD transmission during the time of misdetection.

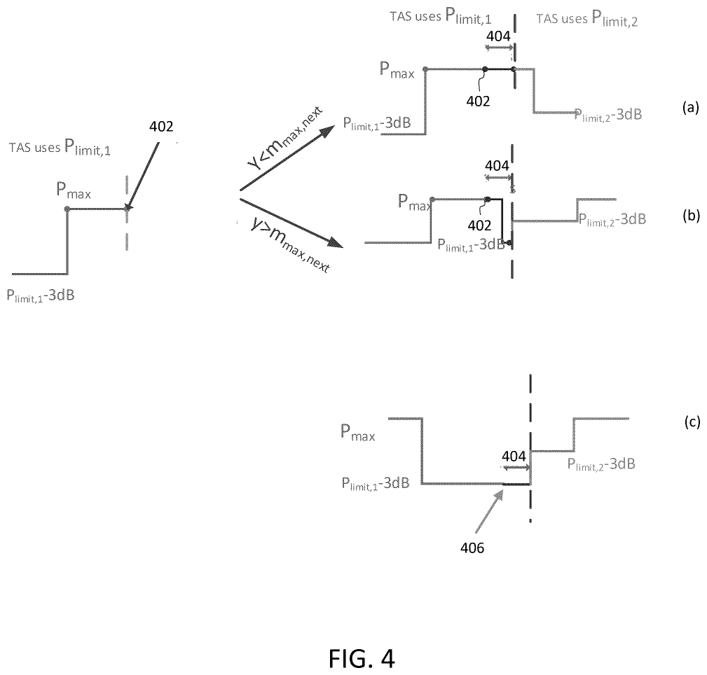

FIG. 4 is a diagram illustrating TAS control for a second scenario based on a misdetection window, according to an embodiment. Assuming that the BPS has a maximum misdetection duration of y sub-windows, then the TAS has different manners of control as set forth below.

As shown in (a), when the BPS detects no object at 402 and the TAS is transmitting at Pₘₐₓ, the TAS may estimate a number mₘₐₓ, next of upcoming consecutive Pₘₐₓ sub-windows while operating at the lower Pₗᵢₘᵢₜ (P_{limit,1}). If this number mₘₐₓ, next is greater than or equal to y sub-windows 404, then the TAS may switch to the higher Pₗᵢₘᵢₜ (P_{limit,2}) directly as the transmission of Pₘₐₓ is the same.

As shown in (b), if the number mₘₐₓ, next of upcoming consecutive Pₘₐₓ sub-windows is less than the y sub-windows 404, then TAS may delay the switching to the higher Pₗᵢₘᵢₜ (P_{limit,2}) for y sub-windows after the BPS detects no object.

As shown in (c), when BPS detects no object at 406 and the TAS is transmitting at Pₗᵢₘᵢₜ (dBm)-3 dB while operating at the lower Pₗᵢₘᵢₜ (P_{limit,1}), then TAS may delay the switching to the higher Pₗᵢₘᵢₜ (P_{limit,2}) for the y sub-windows 404 after the BPS detects no object at 406.

For the second type of BPS, the BPS may detect the proximity of an object and its movement direction (e.g., whether the object is moving closer or farther away). This BPS has two decision variables. A first decision variable may indicate the presence of the object within or outside of a proximity region, while a second decision variable may indicate the direction of the object or if the object is stationary. The BPS may detect the presence of an object regardless of whether it is within or outside of the proximity region.

Mutual operation between the TAS and the BPS may allow for regulatory compliance for scenarios of object misdetection of the second type of BPS.

As described above for the first scenario in which an object appears in front of the UE after a duration during which no object was present, mis-detection may yield non-compliance with respect to the total average PD.

For a BPS with a max y sub-windows of misdetection and proximity region at z cm, a lower power P_{limit,1} may be applied if an object is present in the sensor proximity and a higher power P_{limit,2} may be applied if the object is outside of the sensor proximity region. The BPS may pass the direction of the object to the TAS, and the TAS may operate as set forth below.

First, if the object direction is toward the UE, the TAS may directly lower the Pₗᵢₘᵢₜ from P_{limit,2} to P_{limit,1}, or the TAS may lower the target power based on the value of y while operating at the higher Pₗᵢₘᵢₜ value (P_{limit,2}).

Second, if the object direction is away from the UE, the TAS may use the full target power while keeping the operation at the higher Pₗᵢₘᵢₜ value (P_{limit,2}).

Third, if the object is stationary, the TAS may operate by lowering the target power or maintaining it while operating with the higher Pₗᵢₘᵢₜ value (P_{limit,2}).

Fourth, if the BPS cannot detect the directionality of the object, then the object is not present or the BPS has failed to detect the object. The TAS may apply the lower target PD as before while operating at the higher Pₗᵢₘᵢₜ value (P_{limit,2}).

Fifth, for any scenario, the TAS may operate in accordance with a worst case scenario and lower the target PD.

For the second scenario, an object was close to the UE and then is no longer detected resulting in the Pₗᵢₘᵢₜ changing from a low value (P_{limit,1}) to a high value (P_{limit,2}), which may occur as a misdetection indicating that no object is there, when the object remains present. Mutual operation of the TAS and the second type of BPS may overcome this issue and guarantee the compliance.

For example, assuming a BPS with a max y sub-windows of misdetection, and proximity region at z cm with lower Pₗᵢₘᵢₜ value P_{limit,1} when an object presents at the sensor proximity, and higher Pₗᵢₘᵢₜ value P_{limit,2} when the object is outside the sensor proximity region, the TAS may operate as set forth below.

First, if the object direction is toward the UE, the TAS may continue to operate using its current lower Pₗᵢₘᵢₜ.

Second, if the object direction is away from the UE or stationary, or if the BPS cannot detect the direction, the TAS may use the full target PD or the TAS may operate as described above with respect to the second scenario for the first type BPS.

Joint operation between the TAS and the BPS may also be provided for another TAS algorithm that considers the coupling effects of different antennas on the human object (e.g., spatial TAS).

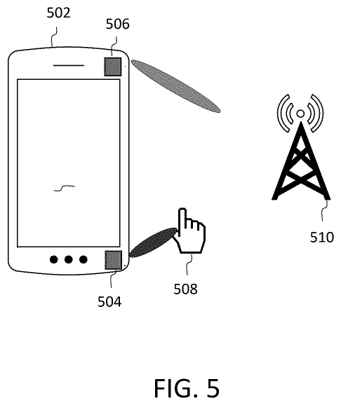

FIG. 5 is a diagram illustrating a UE with two antennas, according to an embodiment. Specifically, a first antenna 504 is disposed at the top of a UE 502. And a second antenna 506 is disposed at the bottom of the UE 502. The first antenna 504 and the second antenna 506 have the same channel quality, but the lower antenna 504 has a human object 508 in front of it. The first antenna 504 and the second antenna 506 are in communication with a base station 510. The second antenna 506 operates with lower Pₗᵢₘᵢₜ. The spatial TAS may operate with the antenna having the higher Pₗᵢₘᵢₜ.

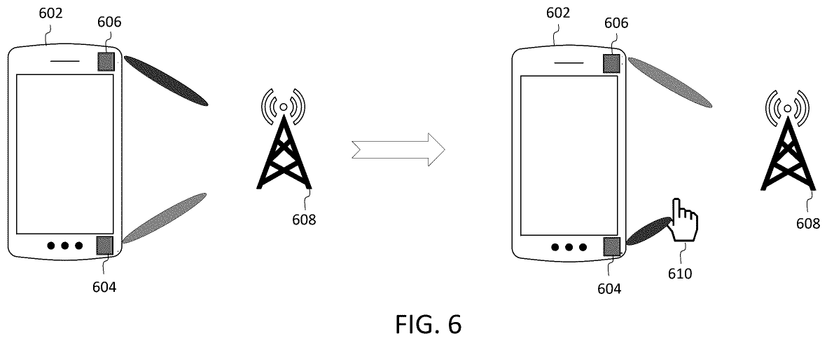

FIG. 6 is a diagram illustrating antenna switching by the spatial TAS for highest power transmission, according to an embodiment. For example, for a UE 602 with a first antenna 604 and a second antenna 606, when there is no object in front of either antenna, the spatial TAS chooses to allow for transmission over the first antenna 604 (assuming it has the highest Pₗᵢₘᵢₜ) to a base station 608. If a human object 610 moves into proximity with the first antenna 604, assuming the BPS can detect the human object 610, the TAS may compute the best antenna to perform transmission and may switch to the second antenna 606, where transmission occurs with higher power independent from a transmission history of the first antenna 604, as both antennas are uncoupled.

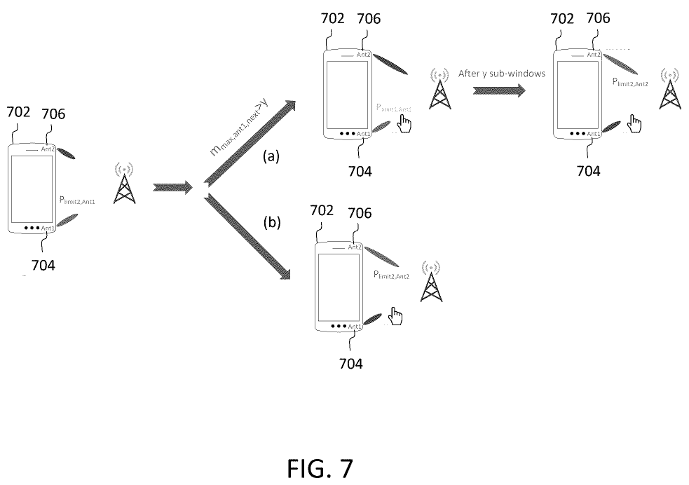

FIG. 7 is a diagram illustrating spatial TAS control for a scenario in which no objects are in close proximity to the antennas, according to an embodiment. Assuming there is a BPS1 for a first antenna 704 and a BPS2 for a second antenna 706 of the UE 702, the Pₗᵢₘᵢₜ corresponding to each antenna may be determined based on the detection of each BPS. For example, upon the detection of an object 708 in front of the transmitting first antenna 704, with no object detected at the second antenna 706, and assuming that BPS1 has a false alarm that lasts for maximum y sub-windows, the spatial TAS may operate as set forth below.

As shown in branch (a), the spatial TAS may estimate the number m_{max,ant1,next} of consecutive sub-windows that can transmit with Pₘₐₓ on the first antenna 704. If the number is more then y sub-windows, then the spatial TAS may lower Pₗᵢₘᵢₜ at the first antenna 704 and continue transmission on the first antenna 704. After y sub-windows, if BPS1 detection remains the same, the spatial TAS may switch to the second antenna 706 with the higher Pₗᵢₘᵢₜ.

Alternatively, as shown in branch (b), the spatial TAS may decrease the Pₗᵢₘᵢₜ at the first antenna 704 and enable immediate antenna switching to the second antenna 706.

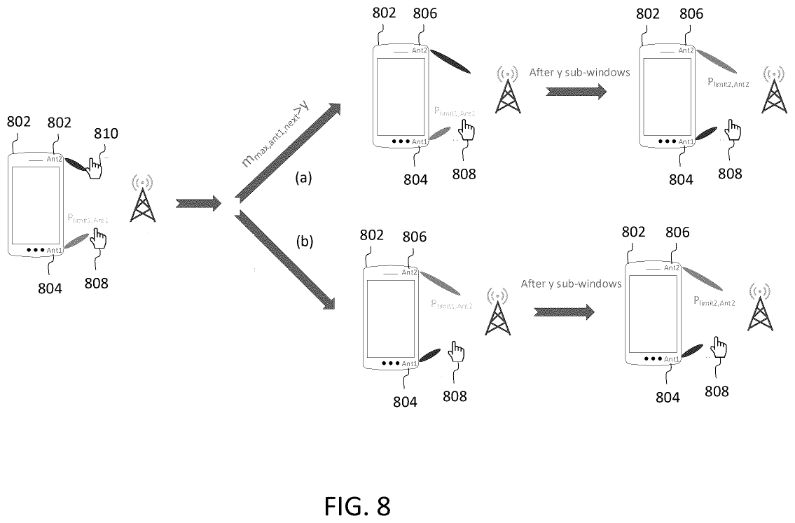

FIG. 8 is a diagram illustrating spatial TAS control for a scenario in which respective objects are originally in close proximity to the antennas, according to an embodiment.

A first object 808 may be in close proximity to a first antenna 804 and a second object 810 may be in close proximity to a second antenna 806 of a UE 802, which lowers the Pₗᵢₘᵢₜ at both antennas. While the UE 802 was transmitting at the first antenna 804, BPS2 determines that second object 810 at the second antenna 806 is removed. Assuming that a misdetection at BPS2 may last for a maximum of y sub-windows, the spatial TAS may operate as set forth below.

As shown in branch (a), The spatial TAS may estimate the number m_{max,ant1,next} of next consecutive sub-windows that can transmit with Pₘₐₓ at the first antenna 804. If this number of sub-windows is larger than or equal to y, the TAS may continue transmission on the first antenna 804 for y sub-windows while operating at the lower Pₗᵢₘᵢₜ for the first antenna 804. After y sub-windows, if the BPS2 determination of no object remains the same, the spatial TAS may switch to the second antenna 806 and operate with the higher Pₗᵢₘᵢₜ at the second antenna 806.

Alternatively, as shown in branch (b) the spatial TAS may switch immediately to the second antenna 806 but start the transmission at the second antenna with its previous lower Pₗᵢₘᵢₜ for y sub-windows. After y sub-windows and ensuring that the BPS2 determination is not a misdetection, the spatial TAS may operate at the higher Pₗᵢₘᵢₜ at the second antenna 806.

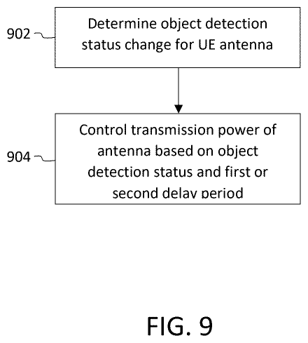

FIG. 9 is a flowchart illustrating a method for controlling transmission power of an antenna. At 902, a proximity senor of the UE determines an object detection status change for a first antenna of the UE. At 904, A processor of the UE controls a transmission power of the first antenna based on the object detection status and one of a first delay period for initial object detection by the proximity sensor or a second delay period of detection status change certainty. The transmission power changes between an upper power level and a lower power level in accordance with a TAS.

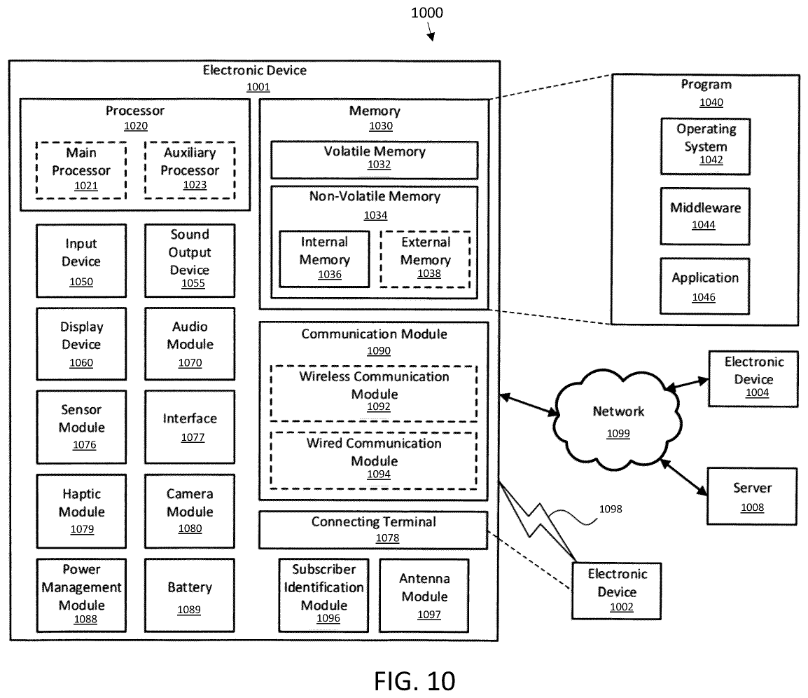

FIG. 10 is a block diagram of an electronic device in a network environment 1000, according to an embodiment.

Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) card 1096, or an antenna module 1097. In one embodiment, at least one (e.g., the display device 1060 or the camera module 1080) of the components may be omitted from the electronic device 1001, or one or more other components may be added to the electronic device 1001. Some of the components may be implemented as a single integrated circuit (IC). For example, the sensor module 1076 (e.g., a fingerprint sensor, an iris sensor, or an illuminance sensor) may be embedded in the display device 1060 (e.g., a display).

The processor 1020 may execute software (e.g., a program 1040) to control at least one other component (e.g., a hardware or a software component) of the electronic device 1001 coupled with the processor 1020 and may perform various data processing or computations.

As at least part of the data processing or computations, the processor 1020 may load a command or data received from another component (e.g., the sensor module 1076 or the communication module 1090) in volatile memory 1032, process the command or the data stored in the volatile memory 1032, and store resulting data in non-volatile memory 1034. The processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or execute a particular function. The auxiliary processor 1023 may be implemented as being separate from, or a part of, the main processor 1021.

The auxiliary processor 1023 may control at least some of the functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). The auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034. Non-volatile memory 1034 may include internal memory 1036 and/or external memory 1038.

The program 1040 may be stored in the memory 1030 as software, and may include, for example, an operating system (OS) 1042, middleware 1044, or an application 1046.

The input device 1050 may receive a command or data to be used by another component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. The display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. The audio module 1070 may obtain the sound via the input device 1050 or output the sound via the sound output device 1055 or a headphone of an external electronic device 1002 directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device 1002 directly (e.g., wired) or wirelessly. The interface 1077 may include, for example, a high-definition multimedia interface (HDMI), a universal serial bus (USB) interface, a secure digital (SD) card interface, or an audio interface.

A connecting terminal 1078 may include a connector via which the electronic device 1001 may be physically connected with the external electronic device 1002. The connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or an electrical stimulus which may be recognized by a user via tactile sensation or kinesthetic sensation. The haptic module 1079 may include, for example, a motor, a piezoelectric element, or an electrical stimulator.

The camera module 1080 may capture a still image or moving images. The camera module 1080 may include one or more lenses, image sensors, image signal processors, or flashes. The power management module 1088 may manage power supplied to the electronic device 1001. The power management module 1088 may be implemented as at least part of, for example, a power management integrated circuit (PMIC).

The battery 1089 may supply power to at least one component of the electronic device 1001. The battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the AP) and supports a direct (e.g., wired) communication or a wireless communication. The communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as BLUETOOTH™, wireless-fidelity (Wi-Fi) direct, or a standard of the Infrared Data Association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. The antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

Commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. All or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a proximity sensor of a user equipment (UE), an object detection status change for a first antenna of the UE; and
controlling, by a processor of the UE, a transmission power of the first antenna based on the object detection status and one of a first delay period for initial object detection by the proximity sensor or a second delay period of detection status change certainty,
wherein the transmission power changes between an upper power level and a lower power level in accordance with a time-averaged specific absorption rate (SAR) (TAS).

2. The method of claim 1, wherein controlling the transmission power comprises:
lowering an average power density (PD) for the transmission power based on the first delay period, a first PD corresponding to a first upper power level when a first average power level is applied for object detection, and a second PD corresponding to a second upper power level when a second average power level is applied for object non-detection.

3. The method of claim 2, wherein the object detection status change comprises changing from a non-detection state to a detection state, and further comprising:
determining by the proximity sensor that a detected object is moving toward the UE, and controlling the transmission power comprises decreasing from a first average power level corresponding to object non-detection to a second average power level corresponding to object detection; or
determining by the proximity sensor that the detected object is moving away from the UE, and controlling the transmission power comprises maintaining the first average power level corresponding to object non-detection.

4. The method of claim 1, wherein the object detection status change comprises a change from a detection state to a non-detection state, and controlling the transmission power comprises adjusting the transmission power based on the second delay period.

5. The method of claim 4, wherein the antenna transmits at the upper power level, the second delay period is less than or equal to a number of remaining sub-windows remaining in the upper power level, and controlling the transmission power comprises:
increasing from a first average power level that corresponds to object detection to a second average power level that corresponds to object non-detection after the number of remaining sub-windows.

6. The method of claim 4, wherein the antenna transmits at the upper power level, the second delay period is greater than a number of remaining sub-windows in the upper power level, and controlling the transmission power comprises:
increasing from a first average power level that corresponds to object detection to a second average power level that corresponds to object non-detection after the second delay period.

7. The method of claim 4, wherein the antenna transmits at the lower power level that corresponds to object detection, and controlling the transmission power comprises:
increasing from a first average power level that corresponds to object detection to a second average power level that corresponds to object non-detection after the second delay period.

8. The method of claim 4, further comprising:
determining by the proximity sensor that a detected object is moving toward the UE, and controlling the transmission power comprises maintaining a first average power level corresponding to object detection; or
determining by the proximity sensor that the detected object is moving away from the UE, and controlling the transmission power comprises increasing from the first average power level corresponding to object detection to a second average power level corresponding to non-object detection.

9. The method of claim 1, wherein the object detection status change comprises changing from a non-detection state to a detection state, controlling the transmission power comprises decreasing an average power level, and further comprising:
switching a transmission from the first antenna to a second antenna of the UE, wherein the second antenna transmits at a second average power level that is higher than the decreased average power level of the first antenna.

10. The method of claim 9, wherein the transmission is switched to the second antenna after the first delay period.

11. The method of claim 1, wherein the UE comprises a second antenna, the object detection status change comprises changing from a detection state at the first antenna and the second antenna to a non-detection state at the second antenna, and further comprising:
switching a transmission from the first antenna to the second antenna, wherein the second antenna transmits at a first average power level that is higher than a second average power level of the first antenna.

12. The method of claim 11, wherein the transmission is switched to the second antenna after the second delay period.

13. A user equipment (UE) comprising:
a processor; and
a non-transitory computer readable storage medium storing instructions that, when executed, cause the processor to:
determine, by a proximity sensor of the UE, an object detection status change for a first antenna of the UE; and
control a transmission power of the first antenna based on the object detection status and one of a first delay period for initial object detection by the proximity sensor or a second delay period of detection status change certainty,
wherein the transmission power changes between an upper power level and a lower power level in accordance with a time-averaged specific absorption rate (SAR) (TAS).

14. The UE of claim 13, wherein, in controlling the transmission power, the instructions further cause the processor to:
lower an average power density (PD) for the transmission power based on the first delay period, a first PD corresponding to a first upper power level when a first average power level is applied for object detection, and a second PD corresponding to a second upper power level when a second average power level is applied for object non-detection.

15. The UE of claim 14, wherein the object detection status change comprises changing from a non-detection state to a detection state, and the instructions further cause the processor to:
determine by the proximity sensor that a detected object is moving toward the UE, and, in controlling the transmission power, the instructions further cause the processor to decrease from a first average power level corresponding to object non-detection to a second average power level corresponding to object detection; or
determine by the proximity sensor that the detected object is moving away from the UE, and, in controlling the transmission power, the instructions further cause the processor to maintain the first average power level corresponding to object non-detection.

16. The UE of claim 13, wherein the object detection status change comprises a change from a detection state to a non-detection state, and, in controlling the transmission power, the instructions further cause the processor to adjust the transmission power based on the second delay period.

17. The UE of claim 16, wherein the antenna transmits at the upper power level:
wherein the second delay period is less than or equal to a number of remaining sub-windows remaining in the upper power level, and, in controlling the transmission power, the instructions further cause the processor to increase from a first average power level that corresponds to object detection to a second average power level that corresponds to object non-detection after the number of remaining sub-windows; or
wherein the second delay period is greater than a number of remaining sub-windows in the upper power level, and, in controlling the transmission power, the instructions further cause the processor to increase from a first average power level that corresponds to object detection to a second average power level that corresponds to object non-detection after the second delay period.

18. The UE of claim 16, wherein the antenna transmits at the lower power level that corresponds to object detection, and, in controlling the transmission power, the instructions further cause the processor to:
increase from a first average power level that corresponds to object detection to a second average power level that corresponds to object non-detection after the second delay period.

19. The UE of claim 13, wherein the object detection status change comprises changing from a non-detection state to a detection state, controlling the transmission power comprises decreasing an average power level, and the instructions further cause the processor to:
switch a transmission from the first antenna to a second antenna of the UE, wherein the second antenna transmits at a second average power level that is higher than the decreased average power level of the first antenna.

20. The UE of claim 13, wherein the UE comprises a second antenna, the object detection status change comprises changing from a detection state at the first antenna and the second antenna to a non-detection state at the second antenna, and instructions further cause the processor to:
switch a transmission from the first antenna to the second antenna, wherein the second antenna transmits at a first average power level that is higher than a second average power level of the first antenna.
